(19) United States
(12) Patent Application Publication
(10) Pub. No.: US 2012/0067477 A1
(43) Pub. Date: Mar. 22, 2012

(54) TIRE TREAD HAVING ASYMMETRIC CHAMFERING

(75) Inventors: Michael A. Berzins, Brecksville, OH (US); Jacob R. Kidney, Wadsworth, OH (US)

(73) Assignee: Bridgestone Americas Tire Operations, LLC, Nashville, TN (US)

(21) Appl. No.: 12/884,811

(22) Filed: Sep. 17, 2010

(51) Int. Cl. B60C 11/03

(52) U.S. Cl. 152/209.15

(57) ABSTRACT

A pneumatic tire having an asymmetrically chamfered tread that promotes desired plysteer residual aligning torque and/or plysteer residual cornering force. The tire comprises a tread having a set of first blocks on a first side of an equatorial plane, and a set of second blocks on a second side of the equatorial plane. The first and second blocks are defined at least in part by a top surface, one or more circumferentially extending grooves, and a plurality of laterally extending grooves. The laterally extending grooves define leading edges and trailing edges of the blocks. The boundaries between the leading edges and top surfaces of a plurality of the first blocks, and between the trailing edges and top surfaces of a plurality of the second block, are chamfered. The boundaries between the trailing edges and top surfaces of the first blocks, and between the boundaries between the leading edges and top surfaces of the second blocks, are substantially unchamfered.

### FIELD OF INVENTION

The present disclosure is directed to tires having treads with asymmetrically placed chamfers. More particularly, the present application is directed to tires having treads with asymmetrically placed chamfers that affect positive or negative plysteer residual aligning torque and/or plysteer residual cornering force.

### BACKGROUND

The interaction of the tires of a moving vehicle with the road surface cause a variety of forces and torques that can cause deviation from stable, straight-line driving. These torques and forces are dependent in part on tread design, and may under certain circumstances also depend on the shape of the road, which may be crowned or canted. One such torque, the “plysteer residual aligning torque,” (“PRAT”) is produced on a tire tread at the footprint that causes a twisting force on the tire at a zero slip angle. An exemplary force that can cause deviation from stable, straight-line driving is the “plysteer residual cornering force” (“PRCF”), which is a force produced on a tire tread in a left or right direction relative to the direction of travel at a zero slip angle.

### SUMMARY

In one embodiment, a pneumatic tire has a tread that promotes desired plysteer residual aligning torque and/or plysteer residual cornering force. The tire comprises a tread having a set of first blocks on a first side of an equatorial plane, and a set of second blocks on a second side of the equatorial plane. The first and second blocks are defined at least in part by a top surface, one or more circumferentially extending grooves, and a plurality of laterally extending grooves. The laterally extending grooves define leading edges and trailing edges of the blocks. The boundaries between the leading edges and top surfaces of a plurality of the first blocks, and between the trailing edges and top surfaces of a plurality of the second blocks, are chamfered. The boundaries between the trailing edges and top surfaces of the first blocks, and between the boundaries between the leading edges and top surfaces of the second blocks, are substantially unchamfered.

### BRIEF DESCRIPTION OF THE DRAWINGS

In the accompanying drawings, structures are illustrated that, together with the detailed description provided below, describe exemplary embodiments of a tire tread having tread blocks with asymmetrically—arranged chamfers. One of ordinary skill in the art will appreciate that a single component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 illustrates a partial plan view of a tire according to one example embodiment.

FIG. 2 illustrates a contact patch corresponding to the tire view illustrated in FIG. 1.

FIG. 3 is a cross-section of a groove along line 3-3 illustrated in FIG. 1.

FIG. 4 is a cross-section of a groove along line 4-4 illustrated in FIG. 1.

FIG. 5 is a cross-section of a groove along line 5-5 illustrated in FIG. 1.

FIG. 6 is a cross-section of a groove along line 6-6 illustrated in FIG. 1.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Block” refers to a discrete tread element defined by a plurality of laterally and circumferentially extending grooves.

“Circumferential” and “circumferentially” refer to lines or directions extending along the perimeter of the surface of the tread parallel to the equatorial plane perpendicular to the axial direction of the tire.

“Equatorial plane” refers to the plane that is perpendicular to the tire's axis of rotation and passes through the center of the tire's tread.

“Groove” refers to an elongated void area in the tread of the tire that extends generally circumferentially, generally laterally, or at an angle relative to the circumferential and/or lateral directions, in a straight, angled, curved or zig-zag manner.

“Lateral” or “laterally” refer to a direction along the tread of the tire going from one sidewall of the tire to the other sidewall.

“Radial” or “radially” refer to a direction perpendicular to the axis of rotation of the tire.

“Plysteer residual aligning torque” or “PRAT” refers to a moment on the tire, expressed in Newton-meters (N-m) or foot-pounds (ft-lb), about the z-axis produced at the tread footprint at a zero slip angle.

“Plysteer residual cornering force” or “PRCF” refers to a force on the tire, expressed in Newtons (N), in the y-direction produced at the tread footprint at a zero slip angle.

“Sidewall” refers to that portion of the tire between the tread and the bead.

“Tread” refers to that portion of the tire that comes into contact with the road under normal load.

The Society of Automotive Engineers J670e (“the SAE Standard”) defines a right-handed, orthogonal coordinate system useful in describing directional forces and moments on a tire. The SAE Standard defines the positive x-axis as pointing in a direction that is parallel with a tire's forward direction, the positive y-axis as pointing to the right side of the tire's forward direction as viewed from the perspective of one looking in the positive x-direction, and the positive z-axis pointing toward the road surface.

The terms “inward” and “inwardly” refer to a general direction toward the equatorial plane of the tire, whereas “outward” and “outwardly” refer to a general direction away from the equatorial plane of the tire and toward the sidewall of the tire. Thus, when relative directional terms such as “inner” and “outer” are used in connection with an element, the “inner” element is spaced closer to the equatorial plane of the tire than the “outer” element. The “right side” of the tire refers to the portion of the tire located in the positive y-direction relative to the equatorial plane, while the “left side” of the tire refers to the portion of the tire located in the negative y-direction relative to the equatorial plane.

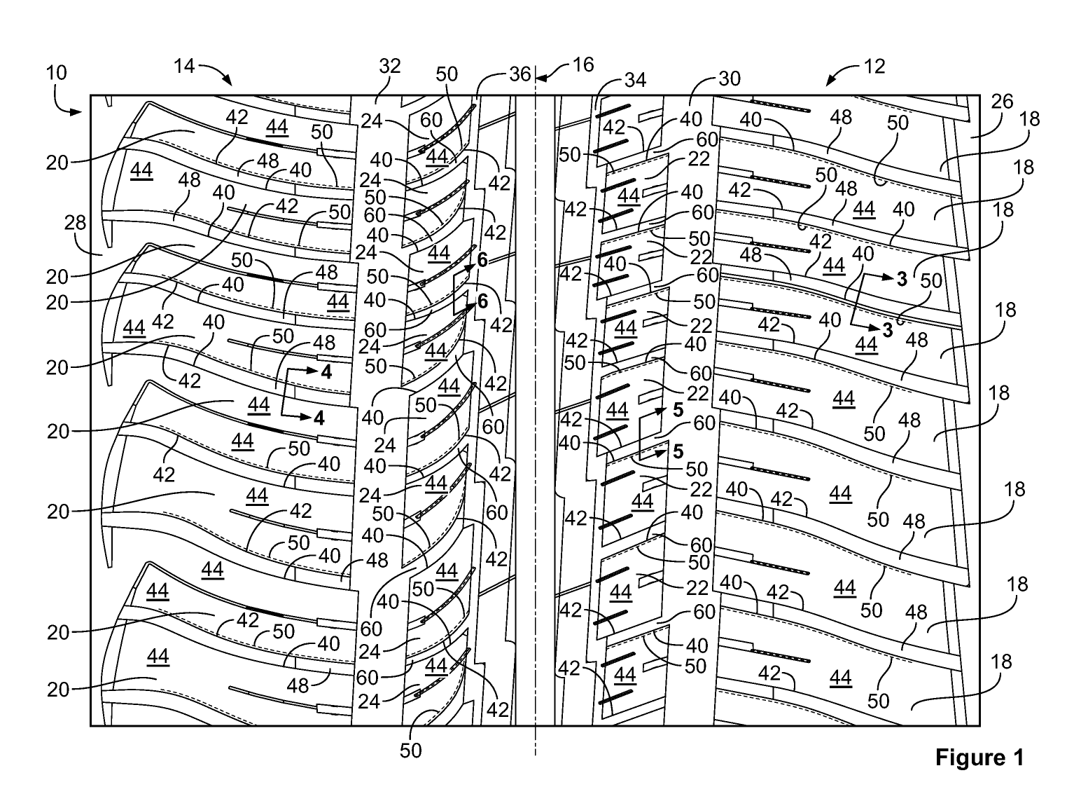

FIG. 1 illustrates a partial plan view of an exemplary tire tread 10. As shown in FIG. 1, the tire tread 10 has a first side 12 and second side 14 separated by equatorial plane 16, the first side 12 to the right of the equatorial plane 16 and the second side 14 to the left of the equatorial plane 16. The first side 12 and second side 14 each have a series of outward circumferentially disposed blocks 18, 20 and a set of inward circumferentially disposed blocks 22, 24.

The first outward circumferentially disposed blocks 18 are bordered laterally and defined in part by the first sidewall 26 and first circumferential groove 30. Likewise, the second outward circumferentially disposed blocks 20 are bordered laterally and defined in part by the second sidewall 28 and second circumferential groove 32. In the illustrated embodiment, the outward circumferentially disposed blocks 18, 20 are the outermost blocks on the tire tread 10. The first inward circumferentially disposed blocks 22 are bordered laterally by the first circumferential groove 30 and third circumferential groove 34. The second inward circumferentially disposed blocks 24 are bordered laterally by the second circumferential groove 32 and fourth circumferential groove 36. The outward circumferentially disposed blocks 18, 20, are disposed adjacent the first and second sidewall 26, 28, respectively, while the inward circumferentially disposed blocks 22, 24 are disposed closer to the equatorial plane 16 than the outward circumferentially disposed blocks 18, 20.

The tire tread 10 shown in FIG. 1 is unidirectional. As shown in FIG. 1, each of the outward circumferentially disposed blocks 18, 20 has a top surface 44, and also has a leading edge 40 and a trailing edge 42 defined by generally laterally extending outer grooves 48. The inward circumferentially disposed blocks 22, 24 also have a top surface 44, and their leading edges 40 and trailing edges 42 are defined by generally laterally extending inner grooves 60. As discussed further below, when the tire is moving in a forward direction the portion of the top surface 44 of a particular block closest to the leading edge 40 will come into contact with the road surface first, and the portion of the top surface 44 closest to the trailing edge 42 will come into contact with the road surface at a later time. Likewise, the portion of the top surface 44 closest to the leading edge 40 will lift off of the road surface first, to be followed at a later time by the portion of the top surface 44 closest to the trailing edge 42. As can be seen in FIG. 1, the generally laterally extending outer and inner grooves 48, 60 are not perpendicular to the equatorial plane 16, and instead extend generally in the direction from the first sidewall 26 to the second sidewall 28. While the generally laterally extending outer and inner grooves 48, 60 are curved in the illustrated embodiment, these grooves may also be linear, and may extend in a direction generally perpendicular to the equatorial plane 16. While the tire tread illustrated in FIG. 1 is that of a unidirectional tire, the tread configurations described herein are also applicable to non-directional tires.

As shown in FIG. 1, the first outward circumferentially disposed blocks 18 and first inward circumferentially disposed blocks 22 have a chamfer 50 between their leading edges 40 and top surfaces 44. In the illustrated embodiment, the chamfers 50 on the first outward circumferentially disposed blocks 18 extend only partially across the leading edges 40 of the outward circumferentially disposed blocks 18. The chamfers 50 on the first inward circumferentially disposed blocks 22, on the other hand, extend across the entire leading edges 40 of the blocks 22.

With continued reference to FIG. 1, blocks shown on the second side 14 of the tire tread 10 have chamfers 50 disposed between the top surfaces 44 and the trailing edges 42 of the blocks. In particular, the second outward circumferentially disposed blocks 20 and second inward circumferentially disposed blocks 24 have chamfers 50 between their trailing edges 42 and top surfaces 44. The chamfers 50 on the second outward circumferentially disposed blocks 20 extend only partially across the trailing edges 42 of the blocks 20, while the chamfers 50 on the second inward circumferentially disposed blocks 24 extend across the entire trailing edges 50 of the blocks 24. While the chamfers 50 on the first 22 and second 24 inward circumferentially disposed blocks extend across the entire leading 40 or trailing edges 42, as applicable, in alternative embodiments, chamfers 50 placed on any blocks, whether disposed inwardly or outwardly, may extend only partially across the leading 40 or trailing edges 42, for example across 75% of the leading 40 or trailing edges 42, or within a range of 50% to 100% across the leading 40 or trailing edges 42.

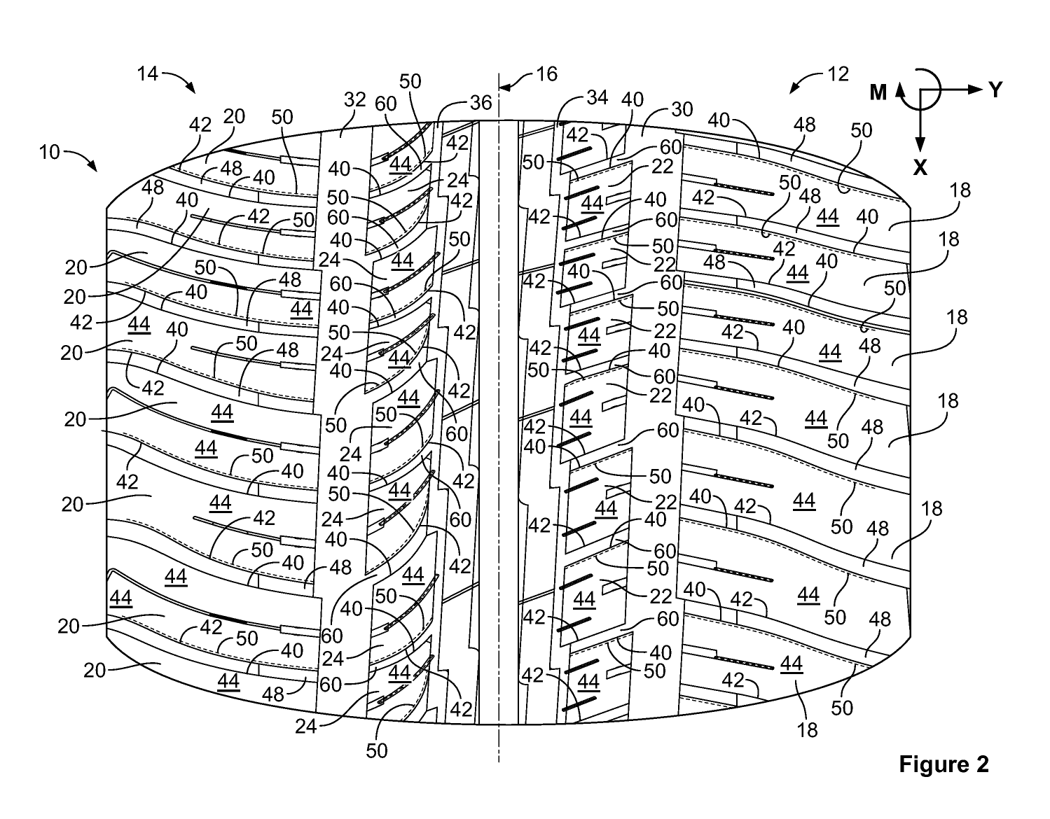

FIG. 2 illustrates a contact patch of the tire tread shown in FIG. 1 as viewed from the road surface looking in the negative z-direction (not shown). As the vehicle (not shown) travels in the positive x-direction and the tire rotates about an axis parallel to the y-direction, the portion of the top surface 44 of a particular block closest to the leading edge 40 will come into contact with the road surface first, and the portion of the top surface 44 closest to the trailing edge 42 contact the road surface at a later time. Likewise, the portion of the top surface 44 closest to the leading edge 40 will lift off of the road surface first, to be followed at a later time by the portion of the top surface 44 closest to the trailing edge 42. When traveling in the positive x-direction, the illustrated tread configuration will promote a torque M exerted by the road surface on the tire in the negative z-direction, corresponding to a negative PRAT, and also promote a force exerted by the road surface on the tire in the negative y-direction, corresponding to a negative PRCF. By switching the configuration such that the blocks on the second side 14 of the tread 10 have chamfers 50 adjacent their leading edges 40 and are completely or substantially unchamfered on their trailing edge 42, and such that blocks on the first side 12 have chamfers 50 on their trailing edge 42 and are completely or substantially unchamfered on their leading edges 40, the PRAT and PRCF promoted by switching to this configuration would be the opposite of what is illustrated—M, and therefore the PRAT promoted by the alternative configuration, would be in the positive z-direction, and PRCF would be exerted in the positive y-direction.

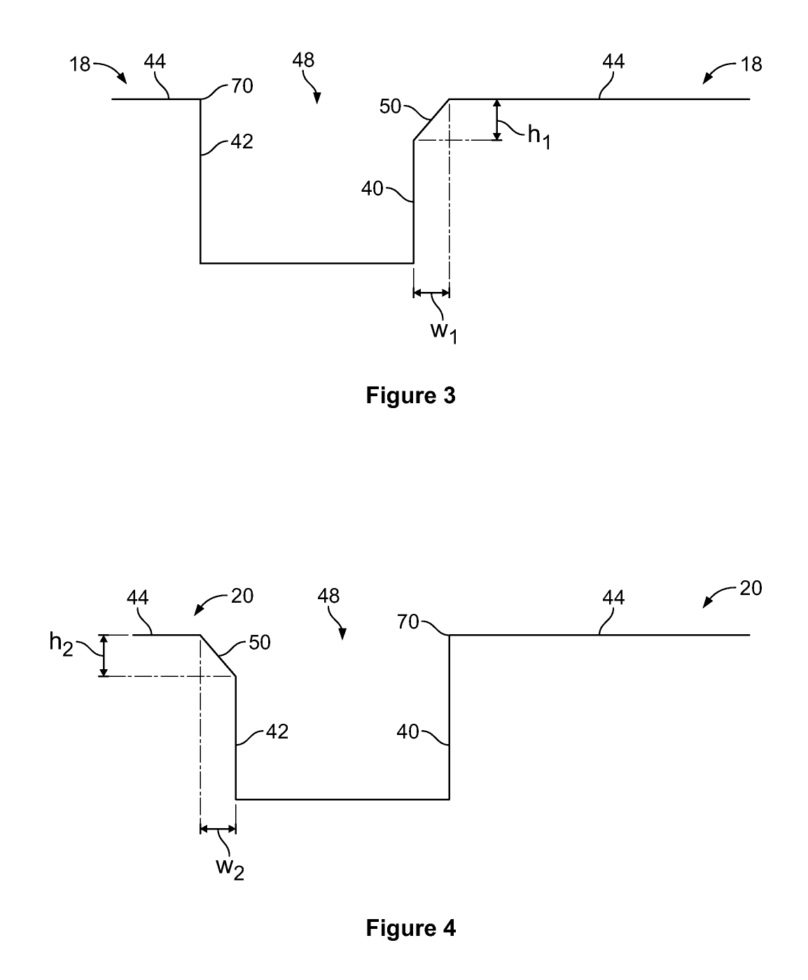

FIGS. 3 and 4, representing cross-sectional views along the lines 3-3 and 4-4 shown in FIG. 1, show the placement of the chamfers 50 on the first and second outward circumferentially disposed blocks 18, 20, respectively. As shown in FIG. 3, the generally laterally extending outer groove 48 separates two first outward circumferentially disposed blocks 18. The leading edge 40 shown on the first outward disposed block 18 adjacent to groove 48 is adjacent a chamfer 50, which is itself adjacent to the top surface 44 of the outward disposed block 18. The illustrated chamfer 50 has a generally flat, angled cross-section, and has a width w₁, which as used herein is measured from the leading edge 40 (or trailing edge 42, as applicable) to the point at which the chamfer 50 meets the horizontal top surface 44, and a height h₁, which as used herein is measured from the top surface 44 to the point at which the chamfer 50 meets the vertical leading edge 40. In the preferred embodiment, both h₁ and w₁ are 0.04 inches, and thus the chamfer 50 is at a 45 degree angle relative to both the top surface 44 and leading edge 40. It should be noted that h₁ and w₁ may take on other heights and widths, and need not be the same. With regard to the first outward disposed block 18 adjacent to groove 48, no chamfer 50 is present at the boundary 70 between the trailing edge 42 and the top surface 44.

As shown in FIG. 4, the chamfer 50 is located between the trailing edge 42 and top surface 44 of the second outward block 20 located adjacent to the generally laterally extending outer groove 48. The chamfer 50 has the same cross-sectional shape as the chamfer 50 shown in FIG. 3, and like the chamfer 50 shown in FIG. 3, the chamfer 50 shown in FIG. 4 is at a 45 degree angle relative to the top surface 44 and trailing edge 42. The height h₂ and width w₂ are also preferably 0.04 inches, but may take on other heights and widths, and need not be the same. The second outward block 20 located adjacent to the generally laterally extending groove 48 has no chamfer at the boundary 70 between the leading edge 40 and top surface 44.

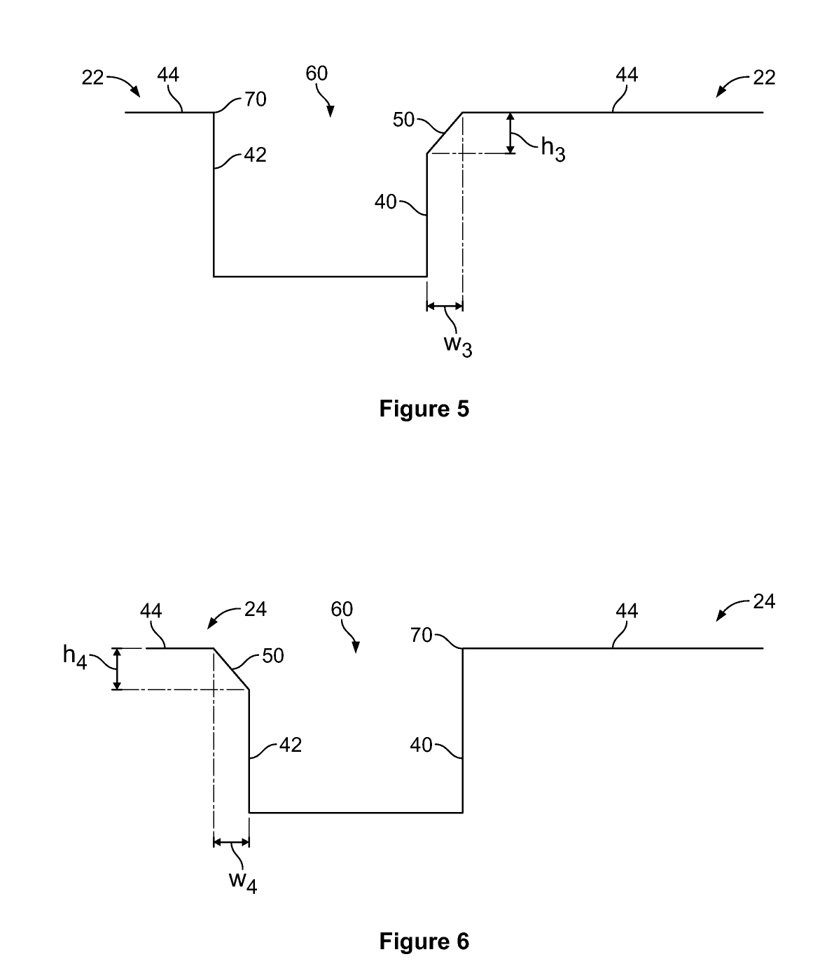

As shown in FIG. 1, other blocks on the tire tread 10 may also exhibit asymmetric chamfering. Like the outward disposed blocks 18, 20, the first and second inward disposed blocks 22, 24 have chamfers adjacent the leading 40 or trailing edges 42. As shown in FIG. 5, which represents a cross-sectional view along the line 5-5 shown in FIG. 1, the first inward disposed block 22 adjacent to groove 48 has a chamfer 50 angled at 45 degrees and having a width w₃ and height h₃ located between its leading edge 40 and top surface 40. The first inward disposed block 22 adjacent to groove 48 has no chamfer present at the boundary 70 between the trailing edge 42 and the top surface 44. Similarly to FIG. 4, the second inward disposed blocks 24 shown in FIG. 6, which represents the cross-sectional view along the line 6-6 shown in FIG. 1, shows a first inward disposed block 22 adjacent to groove 48 having a chamfer 50 angled at 45 degrees and with a width w₄ and height h₄ located between its trailing edge 42 and top surface 40. While the chamfers in the preferred embodiment are angled at 45 degrees, in alternative embodiments the chamfers may be angled within a range of angles, preferably between 30 to 60 degrees as measured from the top surface 44, although other angles may also be used. The second inward disposed block 22 adjacent to groove 48 has no chamfer present at the boundary 70 between the trailing edge 42 and the top surface 44.

A tire tread 10 having the arrangement of chamfered and unchamfered leading 40 and trailing edges 42 shown in FIGS. 1-6 promotes, while traveling in the positive x-direction, a negative PRAT, the direction of which indicated by M in FIG. 2, and the corresponding torque vector of which, when using the right-hand convention, is directed in the negative z-direction. A positive PRAT may be effected by placing chamfers 50 adjacent the leading edges 40 of blocks on the second side 14 of the tread 10, with those blocks having substantially unchamfered trailing edges 42, while on the first side 12 of the tire tread 10 placing chamfers 50 between the trailing edges 42 and top surfaces 44 of the blocks, with those blocks having substantially unchamfered leading edges 40.

While particular sizes and shapes for chamfers 50 have been recited herein, the chamfers 50 may take on other sizes and shapes. For example, the chamfers may be flat surfaces and angles different than 45 degrees, or may be placed at multiple angles. Further, the chamfers 50 may be curved, such as by having a chamfers 50 defined by one or more radii creating a concave curved surface curving toward the body of the tire. In addition, chamfers 50 may, but need not be, the same size on the first 12 and second 14 side of the tire tread 10. The chamfers also need not extend across the entire leading 40 or trailing edge 42 of a particular block, instead they may span partially across the particular block. Likewise, instead of unchamfered trailing edges 42 on the first side 12 and unchamfered leading edges 40 on the second side 14 of the tread 10, some or all of these edges may have some small amount of chamfering and still be substantially unchamfered, although such a configuration promotes less PRAT, positive or negative, than may be otherwise obtainable with completely unchamfered edges. While FIGS. 1-6 illustrate chamfers on first and second inner and outer blocks 18, 20, 22, 24, chamfers 50 may be placed on only the outer blocks 18, 20 or only the inner blocks 22, 24, or combinations thereof, or may be placed on only one of the first side 12 or second side 14. It should be noted, however, that placement on only inner blocks 22, 24 will have limited effect on PRAT. Additionally, while FIG. 1 illustrates chamfers 50 on each of the first and second inner and outer blocks 18, 20, 22, 24, chamfers 50 may be limited to a plurality of such blocks, for example in an alternating fashion wherein every other block is chamfered in the manner described herein, or where most blocks are chamfered in the manner described herein.

1. A pneumatic tire comprising:
a tread having a set of first blocks on a first side of an equatorial plane, the first blocks defined at least in part by a top surface, a first circumferentially extending groove disposed inward from the first blocks, and a plurality of first laterally extending grooves, the first laterally extending grooves defining leading edges and trailing edges of the first blocks;
the tread having a set of second blocks on a second side of the equatorial plane, the second blocks defined at least in part by a top surface, a second circumferentially extending groove disposed inward from the second blocks, and a plurality of second laterally extending grooves, the second laterally extending grooves defining leading edges and trailing edges of the second blocks;
first chamfers located between the leading edges and top surfaces of a plurality of the first blocks, and wherein the boundaries between the trailing edges and top surfaces of the first blocks are substantially unchamfered;
second chamfers located between the trailing edges and top surfaces of a plurality of the second blocks, and wherein the boundaries between the leading edges and top surfaces of the second blocks are substantially unchamfered.

2. The tire of claim 1 wherein the tire is a unidirectional tire, the first blocks are disposed in the positive y-direction relative to the equatorial plane and the second blocks are disposed in the negative y-direction relative to the equatorial plane.

3. The tire of claim 2 wherein the at least one of the first blocks and the at least one of the second blocks are configured to be capable of affecting a negative plysteer residual aligning torque and/or negative plysteer residual cornering force.

4. The tire of claim 1 wherein the tire is a unidirectional tire, the first blocks are disposed in the negative y-direction relative to the equatorial plane and the second blocks are disposed in the positive y-direction relative to the equatorial plane.

5. The tire of claim 4 wherein the plurality of the first blocks and the plurality of the second blocks are configured to be capable of affecting a positive plysteer residual aligning torque and/or positive plysteer residual cornering force.

6. The tire of claim 1 wherein the tire is a non-directional tire.

7. The tire of claim 1 wherein the first and second chamfers located on the first blocks and second blocks are angled chamfers between 30 degrees and 60 degrees from the top surfaces of the first blocks and second blocks.

8. The tire of claim 7 wherein the first and second chamfers located on the first blocks and second blocks are angled chamfers between 40 degrees and 50 degrees from the top surfaces of the first blocks and second blocks.

9. The tire of claim 8 wherein the first and second chamfers located on the first blocks and second blocks are angled at substantially 45 degrees from the top surfaces of the first blocks and second blocks.

10. The tire of claim 9 wherein the first and second chamfers located on the first blocks and second blocks have a width of 0.04 inches.

11. The tire of claim 1 wherein a plurality of the first and second chamfers located on the first blocks and second blocks are curved surfaces.

12. The tire of claim 11 wherein a plurality of the first and second chamfers located on the first blocks and second blocks are concave curved surfaces.

13. The tire of claim 1 wherein a plurality of the first and second chamfers located on the first blocks and second blocks are substantially flat surfaces.

14. The tire of claim 1 wherein a plurality of the first and second chamfers located on the first blocks and second blocks extend across at least 75 percent of the boundaries.

15. The tire of claim 1 further comprising a first sidewall and a second sidewall, wherein the set of first blocks are disposed adjacent the first sidewall, and the set of second blocks are disposed adjacent the second sidewall.

16. The tire of claim 1 further comprising a third circumferentially extending groove disposed outward from the first blocks and defining, at least in part, the set of first blocks, and a fourth circumferentially extending groove disposed outward from the second blocks and defining, at least in part, the set of second blocks.

17. A pneumatic tire comprising:
a tread having a set of first blocks on a first side of an equatorial plane, a set of second blocks on a second side of the equatorial plane, the first and second blocks defined at least in part by a top surface, at least one circumferentially extending groove, and a plurality of laterally extending grooves, the laterally extending grooves defining leading edges and trailing edges of the first and second blocks;
a chamfer located between the leading edges and top surfaces of a plurality of the first blocks, and wherein the boundaries between the trailing edges and top surfaces of the first blocks are substantially unchamfered.

18. The tire of claim 17 further comprising a chamfer located between the trailing edges and top surfaces of a plurality of the second blocks, and wherein the boundaries between the leading edges and top surfaces of the second blocks are substantially unchamfered.

19. A pneumatic tire comprising:
a tread having a set of first inwardly disposed blocks and a set of first outwardly disposed blocks disposed in the positive y-direction relative to an equatorial plane, the first inwardly disposed blocks and first outwardly disposed blocks defined at least in part by a top surface, a plurality of circumferentially extending grooves, and a plurality of first laterally extending grooves, the first laterally extending grooves defining leading edges and trailing edges of the first inwardly disposed blocks and first outwardly disposed blocks;
the tread having a set of second inwardly disposed blocks and a set of second outwardly disposed blocks disposed in the negative y-direction relative to an equatorial plane, the second inwardly disposed blocks and second outwardly disposed blocks defined at least in part by a top surface, a plurality of circumferentially extending grooves, and a plurality of second laterally extending grooves, the second laterally extending grooves defining leading edges and trailing edges of the second inwardly disposed blocks and second outwardly disposed blocks;
first chamfers located between the leading edges and top surfaces of a plurality of the first inwardly disposed blocks and first outwardly disposed blocks, and wherein the boundaries between the trailing edges and top surfaces of the first inwardly disposed blocks and first outwardly disposed blocks are substantially unchamfered;
second chamfers located between the trailing edges and top surfaces of a plurality of the second inwardly disposed blocks and second outwardly disposed blocks, and wherein the boundaries between the leading edges and top surfaces of the second inwardly disposed blocks and second outwardly disposed blocks are substantially unchamfered.

20. The tire of claim 19 wherein first chamfers are located on every alternating block of the plurality of first inwardly disposed blocks and every alternating block of the plurality of first outwardly disposed blocks, and wherein the boundaries between the trailing edges and top surfaces of the first inwardly disposed blocks and first outwardly disposed blocks are substantially unchamfered, and wherein second chamfers are located on every alternating block of the plurality of the second inwardly disposed blocks and every alternating block of the plurality of second outwardly disposed blocks, and wherein the boundaries between the leading edges and top surfaces of the second inwardly disposed blocks and second outwardly disposed blocks are substantially unchamfered.
